(19) United States
(12) Patent Application Publication
(10) Pub. No.: US 2013/0103390 A1
(43) Pub. Date: Apr. 25, 2013

(54) METHOD AND APPARATUS FOR PARAPHRASE ACQUISITION

(71) Applicants: Atsushi FUJITA, Ottawa (CA); Pierre ISABELLE, La Peche (CA)

(72) Inventors: Atsushi FUJITA, Ottawa (CA); Pierre ISABELLE, La Peche (CA)

(21) Appl. No.: 13/655,852

(22) Filed: Oct. 19, 2012

Related U.S. Application Data
(60) Provisional application No. 61/550,142, filed on Oct. 21, 2011.
(60) Provisional application No. 61/603,440, filed on Feb. 27, 2012.

(51) Int. Cl. G06F 17/27

(52) U.S. Cl. 704/9

(57) ABSTRACT

A computer based natural language processing method for identifying paraphrases in corpora using statistical analysis comprises deriving a set of starting paraphrases (SPs) from a parallel corpus, each SP having at least two phrases that are phrase aligned; generating a set of paraphrase patterns (PPs) by identifying shared terms within two aligned phrases of an SP, and defining a PP having slots in place of the shared terms, in right hand side (RHS) and left hand side (LHS) expressions; and collecting output paraphrases (OPs) by identifying instances of the PPs in a non-parallel corpus. By using the reliably derived paraphrase information from a small parallel corpus to generate the PPs, and extending the range of instances of the PPs over the large non-parallel corpus, better coverage of the paraphrases in the language and fewer errors are encountered.

### FIELD OF THE INVENTION

The present invention relates in general to computer based natural language processing, specifically for identifying paraphrases in corpora using statistical analysis.

### BACKGROUND OF THE INVENTION

Expressions that convey the same meaning using different linguistic forms in the same language are called paraphrases. Techniques for generating and recognizing paraphrases play an important role in many natural language processing systems, because “equivalence” is such a basic semantic relationship. Search engines and text mining tools could be more powerful if paraphrases in text are properly recognized. Likewise paraphrases can contribute to improving the performance of algorithms for text categorization, summarization, machine translation, writing aids, reading aids including text simplification, text steganography, question answering, text-to-speech, looking up previous translations in translation memories, and natural language generation. Paraphrasing is applied in a range of applications from word-level replacement to discourse level restructuring. Typically a paraphrase knowledge-base can be defined as a set of equivalence classes of expressions (thesaurus), paraphrase patterns as represented by a transformation grammar, or as a procedure for transforming an input expression into a set of paraphrases, or an exemplar thereof. Naturally the objective is to have as complete a set of associations between the expressions of a language, as is borne out by the language, with as few erroneous associations as possible.

Acquisition of paraphrases has drawn the attention of many researchers. Previous methods typically identify paraphrases from one of the following four types of corpora: (a) monolingual corpus, (b) monolingual parallel corpus, (c) monolingual comparable corpus and (d) bilingual or multilingual parallel corpus. Monolingual parallel corpora are relatively rare, but may arise when there are several translations of a single document into the language for which paraphrases are desired. A monolingual comparable corpus is provided by associating documents on the same topic, such as news stories reporting on the same event and multiple sentences for defining the same headword in different dictionaries. Generally there are vast monolingual corpora of many languages of interest, such as is provided by the Internet. There are only far smaller comparable corpora and parallel corpora. So while monolingual parallel corpora have the most direct information on paraphrases, they have never produced a reasonable scale of paraphrase knowledge. Bilingual or multilingual parallel corpora have been used to generate paraphrase knowledge bases, but, because they are much smaller than monolingual corpora, typically a small fraction of the available paraphrases are observed.

Techniques for mining paraphrases from monolingual corpora rely on the Distributional Hypothesis (Harris, 1954): expressions that appear in the similar context tend to have similar meaning. Because large monolingual corpora are available for many languages of interest, a large number of paraphrase candidates can be acquired (Lin and Pantel, 2001; Bhagat and Ravichandran, 2008). Unfortunately, as the method only relies on the similarity of context (co-occurring expressions), it also extracts many non-paraphrases, such as antonyms and hypernym/hyponym. Words that are frequently substitutable (cat and dog), but are not themselves paraphrases of each other, tend to be identified equally by such methods.

Bilingual parallel corpora have also been used as sources of paraphrases, as per (Bannard and Callison-Burch, 2005, and Zhao et al., 2008). The technique relies on translation between the source language and a “pivot language” to identify paraphrases. Specifically, to the extent that two source expressions are liable to be translated to the same target language expression, they paraphrase each other. Advantageously, the word/phrase alignment within commonly used statistical machine translation (SMT) systems, and the sentence-level equivalence provide useful measures for the probability of two expressions being paraphrases of each other, at two levels of semantics. Unfortunately, bilingual corpora tend to be much smaller than monolingual corpora, and accordingly there is a scarcity of data that comes into play.

More recently paraphrase patterns have been used in paraphrase recognition and generation (Lin and Patel, 2001; Ravichandran and Hovy, 2002; Shinyama et al., 2002; Barzilay and Lee, 2003; Ibrahim et al., 2003; Pang et al., 2003; Szpektor et al., 2004; Zhao et al., 2008; Szpektor and Dagan, 2008). Zhao et al. (2008) teaches using the pivot approach to extract paraphrase patterns from bilingual parallel corpora, and proposes a log linear model to compute the paraphrase likelihood of two patterns, exploits feature functions based on maximum likelihood estimation (MLE) and lexical weighting (LW). The paraphrase patterns are used to generate paraphrases by matching the acquired paraphrase pattern with given input sentence at the syntactic tree level of a parse tree. Their system inherently uses part of speech (POS) labels and parsing of the corpus, which is computationally expensive, and provides one set of constraints for “slot fillers”. Consequently, only smaller bilingual parallel corpora have POS labeling. The reported example extracted 1 million+pairs of paraphrase patterns from 2 million bilingual sentence pairs, with a precision of about ⅔^{rds}, and a coverage of about 84%.

Parsing provides a relatively detailed description of the corpus by identifying POS labels for each word or phrase and underlying structure of sentences, but parsing is itself contentious and subject to error, especially in languages where words have multiple senses/functions.

In general, POS labels alone do not adequately characterize possible slot fillers that are appropriate for each pattern, and those that are not. For instance, “My son solves the mystery” and “My son finds a solution for the mystery” are paraphrases, so the paraphrase pattern (“X solves Y”, “X finds a solution for Y”) works when X=“My son”, Y=“the mystery”. On the other hand, “Salt finds a solution for icy roads” is a weird paraphrase for “Salt solves the problem of icy roads”. Clearly, the paraphrase pattern (“X solves Y”, “X finds a solution for Y”) comes with the hidden restriction that noun X should denote an “animate” entity.

While ⅔^{rds} precision and 84% coverage reported by Zhao et al. (2008) may be better than previous methods, it leaves much to be desired. This pattern method is still dependent on the information contained in the bilingual corpus, which is typically far smaller than available monolingual corpora, which means the coverage of the language is still small. Leveraging the parsed POS structure of the bilingual corpus, Zhao et al. (2008) yields so many inaccurate paraphrase patterns. They suggest using context to improve replacement of paraphrase patterns in context sentences.

Accordingly there is a need for a technique that can more accurately identify paraphrases from corpora, especially a technique that can leverage high volume corpora, and make better use of smaller corpora containing more explicit paraphrase information, such as (multilingual or monolingual) parallel corpora.

### SUMMARY OF THE INVENTION

There are several prior art references on acquiring paraphrase patterns, such as paraphrase pattern acquisition by the addition of contextual constraints to paraphrases (Lin and Pantel, 2001; Callison-burch, 2008; Zhao et al., 2008; 2009) and by looking for phrase patterns that hold similar meaning to a given phrase pattern (Szpektor et al., 2004; Taney, 2010). There has also been some research on manual description of paraphrase patterns (Jacquemin, 1999; Fujita et al., 2007). However, no reference has obtained paraphrases by taking actual paraphrases, generalizing them to form a paraphrase pattern, and then identify an extension of the generalized paraphrase pattern in a non-parallel corpus or large text body other than the parallel corpus from which the actual paraphrases were obtained, to produce as a larger set of paraphrases. Instantiating and checking patterns proposed by some other information source (a parallel corpus), and then producing as output a set of paraphrases that both match one of the patterns and have been observed in the non-parallel corpus has important advantages over prior techniques.

Accordingly, there is provided a computer based natural language processing method for identifying paraphrases in corpora using statistical analysis, the computer based method comprising: deriving a set of starting paraphrases (SPs) from a parallel corpus, each SP having at least two phrases that are phrase-aligned, generating a set of paraphrase patterns (PPs) by identifying shared terms within two aligned phrases of an SP, and defining a PP having slots in place of the shared terms, in right hand side (RHS) and left hand side (LHS) expressions, and collecting output paraphrases (OPs) by identifying instances of the PPs in a non-parallel corpus. The parallel corpus may be a multilingual corpus and deriving the SPs may comprise identifying phrases that are aligned by translation to a common phrase in a pivot language. The parallel corpus may be a multilingual parallel corpus or a monolingual parallel corpus, and the non-parallel corpus may be a unilingual side of the parallel corpus and/or an external monolingual non-parallel corpus.

Deriving the SPs may comprise filtering a set of aligned phrases, for example by applying at least one syntactic or semantic rule for culling SP candidates, removing stop words from SP candidates, removing SP candidates that differ by only stop words, or removing SP candidates that have word subsequences with higher weights than other candidates as candidate paraphrases of a given phrase. Deriving the SPs may comprise taking a parallel corpus having alignment at the morpheme, word, sentence or paragraph level, and generating phrase alignments to the extent possible. Deriving the SPs may comprise taking a parallel corpus having alignment at the phrase level, and cleaning the phrase level alignments to select those most likely to provide strong SPs. Deriving the SPs may comprise taking a multilingual parallel corpus having alignment at the morpheme, word, sentence or paragraph level, and generating word alignments by statistical machine translation, followed by partitioning sentences into phrases. Deriving the SPs may comprise taking a multilingual parallel corpus having alignment at the phrase level, and cleaning the phrase level alignments to select those most likely to provide strong SPs using translation weights from morpheme, word, phrase, sentence, paragraph, context, or metatextual data, levels. Deriving the SPs may comprise taking a multilingual parallel corpus having alignment at the phrase level, and cleaning the phrase level alignments to select those most likely to provide strong SPs using translation weights from alignments from each of two or more pivot languages.

Identifying shared terms may comprise identifying shared terms as words having a “letter same” relation, identifying shared terms as words having a same lemma, identifying shared terms as words associated by lexical derivations or lexical functions, or identifying shared terms by applying morpheme based analysis to the words of the phrases in the SPs.

Collecting OPs may comprise: determining whether each PP has sufficient instantiation in the parallel corpus and discarding PPs that do not, prior to searching the non-parallel corpus, or searching in the non-parallel corpus for the PP, and discarding the PP if there is insufficient instantiation. Collecting OPs may comprise cataloging all slot fillers that occur in the non-parallel corpus in both RHS and LHS instantiations, performing preliminary statistics on the slot fillers and their variety to determine strength of the PP, and constructing a candidate paraphrase for every instantiation having sufficient RHS and LHS instantiations.

Collecting OPs may comprise applying a test to rank a candidate paraphrase for inclusion in the set of OPs. Such a test may comprise computing a similarity of contexts of the instances of the LHS and RHS expressions having the same slot fillers. Such a test may comprise computing a similarity of contexts of the shared terms and slot fillers identified from the PP instances in the non-parallel corpus. Such a test may comprise identifying word forms or semantic classes of slot fillers identified from PP instances in the non-parallel corpus to assess substitutability. Various measures for similarity of contexts (Deza and Deza, 2006) can be used for this purpose.

Further features of the invention will be described or will become apparent in the course of the following detailed description.

### BRIEF DESCRIPTION OF THE DRAWINGS

In order that the invention may be more clearly understood, embodiments thereof will now be described in detail by way of example, with reference to the accompanying drawings, in which:

FIG. 1 is a flow chart showing principal steps in a method in accordance with an embodiment of the present invention;

FIG. 2 is a schematic illustration of documents produced as intermediate steps in accordance with an embodiment of the present invention;

FIGS. 3 and 4 are tables showing statistics regarding the first and second exemplary implementation of the present invention; and

FIGS. 5 and 6 are graphs of statistics regarding the third and fourth exemplary implementation of the present invention.

### DESCRIPTION OF PREFERRED EMBODIMENTS

The present invention generates a large number of paraphrases that have been validated both by parallel corpora and non-parallel corpora data, providing: a large number of paraphrases is generated (wide coverage), but with fewer errors from word associations like hypernym/hyponym/antonym, and cat/dog like associations. As the paraphrases are supported by both parallel and non-parallel corpora data and are more likely to be correct.

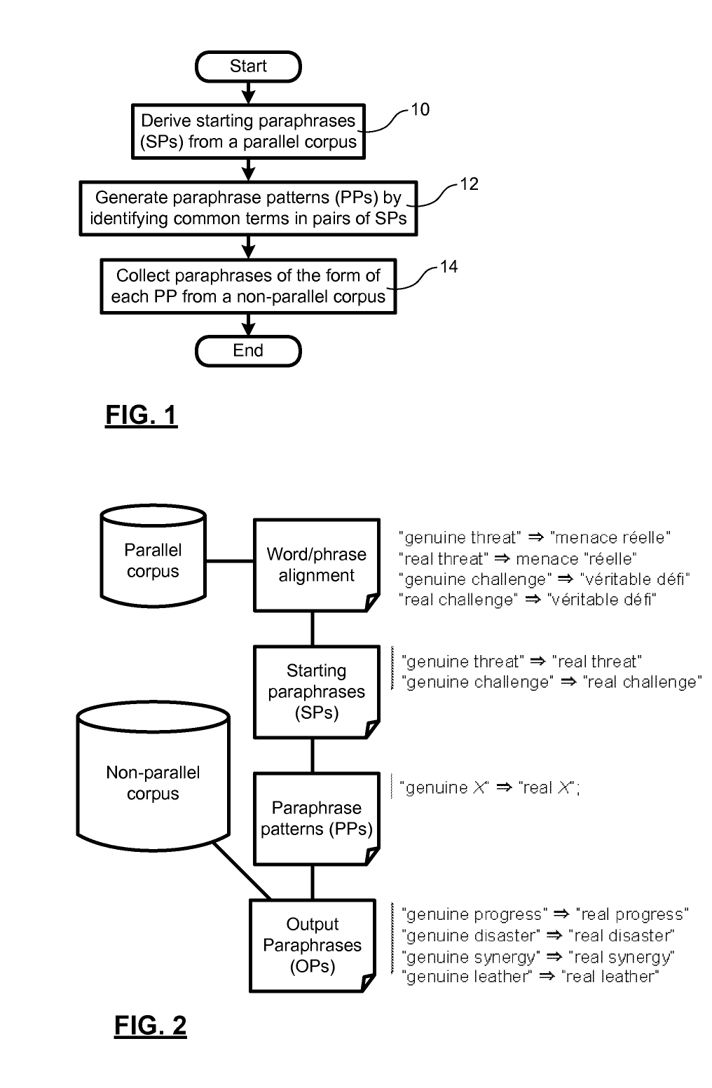

FIG. 1 is a flow chart illustrating principal steps involved in paraphrase mining in accordance with an embodiment of the present invention. The process begins with the derivation of a set of starting paraphrases (SPs) (step 10), from a parallel corpus. The parallel corpus may be a multilingual parallel corpus, or a monolingual parallel corpus, for example. Accordingly the parallel corpus has a set of paraphrases directly derivable, either from the pivot language technique described above, or from the aligned phrases within the monolingual parallel corpus. The direct association of the many phrases in the parallel corpus with each other provides a more reliable source of paraphrase information than monolingual non-parallel corpora, which typically only indirectly support, or fail to support, a statistical probability of a paraphrase relationship between two phrases (e.g., as per the distributional hypothesis). Deriving SPs from parallel corpora may be relatively simple, given the existing alignment of words and/or phrases.

In some cases, alignment is only provided at a level that does not correspond with phrases. For example, sentences or clauses may be aligned, or morphemes or words may be aligned. In such cases, deriving phrase alignments may still be made easier by the existing alignments within the parallel corpus, but may require some further processing. Preferably the parallel corpus is at least aligned at the morpheme, word, phrase, or sentence level. The popular IBM models for word and phrase alignment are excellent candidates. It is known how to generate phrase alignments from the word alignments, as taught, for example by Koehn (2009). Weights for each SP can be assigned based on translation weights at whatever level(s) the corpora are aligned (morpheme, word, phrase, sentence, paragraph, context, metatextual data, etc.). Multiple measures can be combined to define a single score for each SP, as is known in the art.

If the parallel corpus is multilingual, weights can be assigned for each paraphrase based on translation weights for each pivot language (Bannard and Callison-Burch, 2005). Furthermore, within each pivot language, paraphrase relations or other semantic similarity relations, can be used to define pivot classes among the phrases of the pivot language, that more accurately reflect translation equivalence.

Preferably measures are taken to limit erroneous paraphrases, such as may result from errors in phrase/word alignment, for example. Furthermore, culling of the SPs may be desired, for example, based on an uncertainty of the phrase alignments, and/or sentence level alignments of the phrases in question, or with syntactic or semantic rules. For example, Johnson et al. (2007) teaches a technique for filtering out statistically unreliable SPs. In some embodiments it may be preferred to apply special purpose filters, for example to remove all SPs that: differ by only stop words, or all phrases that contain only stop words, or to remove all SPs that differ only by one word being singular in one phrase and plural in the other. Furthermore, contextual similarity may also be used to assess a strength of SPs in some embodiments. At the conclusion of step 10, a list is formed of SPs. Each SP may be formed of phrase pairs, or other groupings. For example, the list of SPs may include: a) “control apparatus”=“control device” b) “movement against racism”=“anti-racism movement” c) “middle eastern countries”=“countries in the middle east”.

In step 12, the SPs are analyzed to identify paraphrase patterns (PPs). This may involve, for each SP having one or more shared terms (i.e., words, morphemes, or word forms in common), generating a candidate PP constructed by taking the shared term(s) out of the phrase, and replacing them with “slots”. For corpora having lemma annotation, base or root forms may be used to identify shared terms in SPs if they differ only in word form. If no lemma annotation is available, word form analysis can be applied to expand on the “letter same” relation to a more general sense of equivalence, and may further apply morpheme-based analysis to identify affixes and other components, to assist in identifying similarities between phrases like “misunderstood conversation” and “dialogue that was not understood”. Further lexical functions and/or lexical derivations, such as those defined in Meaning-Text Theory (Mel'\check{c}uk and Polguère, 1987) can be used to assist in the identification of shared terms. At the very least, trivial forms such as pluralization of nouns in English, would preferably be identified as shared terms. So in the examples, the following PPs may be generated: a) X apparatus=X device b) X against Y=anti-Y X c) X eastern Y=Y in the X east. Each PP has a right hand side (RHS) and left hand side (LHS), that are, with the notation used herein, related by equality.

Because phrase alignment and cleaning of the SPs is not perfect, some incorrect PPs will be obtained. It may be preferable to assess PPs once created (for example as taught in Lin and Pantel, 2001; Szpektor and Dagan, 2008), or add constraints on how they are created (for example as taught in Callison-Burch, 2008; Zhao et al., 2009). One way of assessing the strength of a PP is to measure how many occurrences of the PP are evident in a corpus. The parallel corpus may be used, but more accurately, a larger, non-parallel corpus, is used. So for example a) above, if the non-parallel corpus has some disjoint LHS phrases such as “golgi apparatus”, “playground apparatus”, and some disjoint RHS phrases “rhetorical device”, “literary device”, and a great number of intersecting phrases “scientific apparatus/device”, “patented apparatus/device”, “support apparatus/device”, “lifting apparatus/device”, “sensor apparatus/device”, etc. with some of the intersecting phrases having many instances, the PP “X apparatus=X device” would be a strong PP. PPs that are not representative of a sufficient number of unique instances or of a sufficient total number of instances may be disregarded (to provide minimum support for the paraphrase pattern).

In step 14, the PPs are used to identify output paraphrases (OPs) within the non-parallel corpus. This may involve cataloging all slot fillers that occur in the non-parallel corpus in both RHS and LHS expressions. Some preliminary statistics on the slot fillers and their variety may be computed. So for each candidate slot filler (or tuple of slot fillers if there are multiple slots in the PP) derived from a phrase in the non-parallel corpus that has instances in the RHS and LHS, a candidate paraphrase is generated. Advantageously this candidate has a range of instantiations over the sentences in the non-parallel corpus, and there is clear evidence from the PPs derived from the parallel corpus that these phrases have similar meanings. Significant advantage is also provided by using a non-parallel corpus for assessing candidate paraphrases for inclusion in the set of OPs.

There are a variety of tests that can be applied to rank candidate paraphrases for inclusion in the set of OPs, including those known from monolingual paraphrase techniques (Bhagat and Ravichandran, 2008; Fujita and Sato, 2008). The advantages of applying such analysis only to PPs derived in this manner are clear: the analysis is focused much more tightly as are the searches of the large non-parallel corpus.

Additionally or alternatively, analysis of the similarity of contexts of the instances in the LHS and RHS phrases having the same or similar slot filler(s), may be performed to assess whether the contexts of these phrases match. Matching contexts indicate that the phrases are more likely synonymous. This test is particularly preferred.

Additionally or alternatively, similarity of the shared term(s) in SP (i.e., those that were replaced with slot(s) to generate the PP such as, a) “control” b) “movement” and “racism” c) “middle” and “countries” in the examples above), or the context in which they were found, can be compared with the candidate slot filler(s), to provide a measure of substitutability of the candidate slot filler(s) for the shared term(s). Word form and/or semantic class (such as WordNet), can be used superficially to provide a measure of substitutability for the shared term(s). A static set of contextually similar words (precompiled word cluster), or known set expansion techniques are other alternatives. A context of the shared term(s) determined from the two phrases in the parallel corpus (SP), may be compared with the respective contexts of the candidate slot filler. The context of the shared term may be, for example, a weighted distribution of content words in the vicinity of the two phrases in the corpus (or any other source for context), with some additional weight given for features that overlap the respective contexts of the two phrases. Thus a composite context may be formed representing the shared terms, and this may be compared with a similarly defined context of the candidate slot filler. As some phrases are capable of multiple senses, and the candidate slot filler may be an excellent substitution for the shared term in only some cases, it may be preferred to consider the contexts that most closely match that of the shared term, if identification of the best paraphrases is desired. If the objective is to derive those phrases that are most unambiguously synonymous, then a weighting based on an average and a number of occurrences may be preferred.

In general, a similarity function may be used to compute a similarity between the RHS and LHS instances in the non-parallel corpus, and/or between the shared term(s) and the candidate slot filler. The similarity function may be based on sets of features that relate co-occurring expressions in a fixed-size window around the phrase (bag of words representation) or neighboring expressions on a parse tree.

It is possible to change the order of these steps and obtain substantially the same advantages. Specifically, run a context-based similarity function on the non-parallel corpus to obtain a set of associated phrases. Then test each phrase association by determining whether there is an alignment of phrases in the parallel corpus that 1—directly confirms the phrase association, or 2—defines a PP of which the phrase association is an instance, for which the PP has minimum support.

The paraphrase mining may be iterative, to take an OP knowledge base as the set of SPs, to provide a higher accuracy, broader coverage, paraphrase knowledge base, for example. The process may incorporate several parallel corpora each adding iteratively to the SP set.

Given the fact that non-parallel corpora are typically vastly larger than parallel corpora, the size of the problem space makes it substantially more feasible to identify the phrase alignments, extract the SPs, analyze the SPs to derive the PPs, and then test the PP instances to generate OPs, as shown top to bottom in FIG. 2.

### EXAMPLE 1

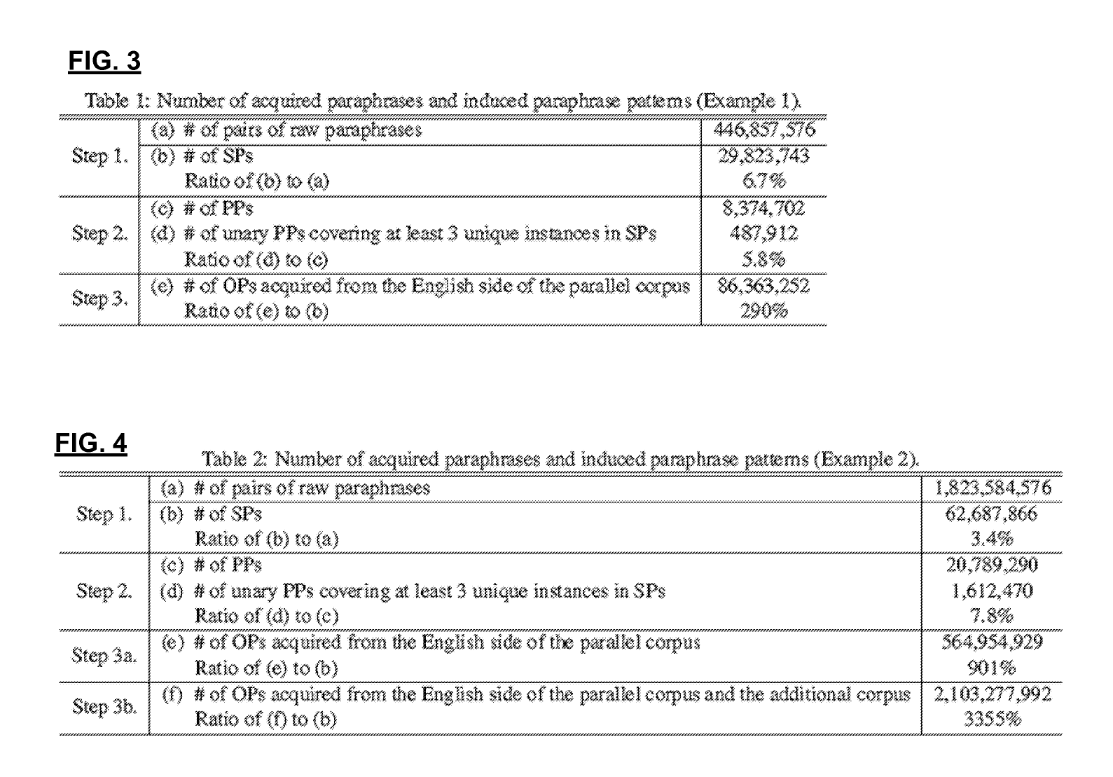

The present invention was tested to show that many English paraphrases can be generated in accordance with the present invention, using a parallel bilingual (English/French) parliamentary corpus. The corpus was version 6 of the Europarl Parallel Corpus, which consists of 1.8 million sentence pairs (50.5 million words in English and 55.5 million words in French). A tokenizer bundled in a phrase-based statistical machine translation system “PORTAGE” (Sadat et al., 2005) was used for the English and French sentences. FIG. 3 is a table showing the number of acquired paraphrases at the various steps in the examples.

Phrase alignments were obtained by a phrase-based statistical machine translation system “PORTAGE” (Sadat et al., 2005), where the maximum phrase length was set to 8. The current PORTAGE system (Larkin et al., 2010) specifically uses Hidden Markov Model (HMM) and IBM2 alignments, both of which were used for these examples. Obtained phrase translations were then filtered by significance pruning (Johnson et al., 2007) with α+ε as the threshold. Thus redundant phrase alignments that are typically included for robustness of phrase-level translation, are removed. A manually compiled list of 442 English stop words and 193 French stop words were used for cleaning up both phrase translations and initial candidates of paraphrases.

From an initial set of cleaned SPs, a filter is applied to remove candidate SPs for which one phrase is a substring of the other. Specifically, let wsubseq(x,y) be a Boolean function that returns true iff x is a word sub-sequence of y. RHS rule: remove <e₁,e₂> from the set SP, iff ∃e₃, <e₁,e₃> ∈ SP, wsubseq(e₃,e₂), and e₃ has a higher weight for being a paraphrase of e₁ than e₂. LHS rule: remove <e₁,e₂> from the set SP, iff ∃e₃, <e₃,e₂> ∈ SP, wsubseq(e₃,e₁), and e₃ has a higher weight for being a source phrase of e₂ than e₁. Once cleaned and filtered, the number of retained SPs was 29,823,743. The effect of the cleaning and filtering was that over 90% of the raw paraphrases were discarded.

The number of unique PPs automatically generated was 8,374,702. Each PP was associated with a list of the shared term(s) that were eliminated to generate the PP. If more than one pair of phrases form a same PP, (e.g., “printer device” and “printer apparatus”, as well as “control device” and “control apparatus” are all in the initial SP leading to the formation of exactly the same PP in two instances) the set of the shared terms for the two identical PPs was retained, and only one copy of the PP was retained.

The obtained PPs were then filtered on the basis of the number of corresponding instances in SPs. The minimum support for a PP was determined to 3: if a PP did not cover at least 3 unique instances in SP, it was discarded. This constraint removed more than 90% of the PPs.

For each PP, a search of the non-parallel corpus was made for the LHS and RHS phrases, and a list of instances were compiled (with stop words removed). Each instance is associated with a unique candidate slot filler. Each candidate slot filler x is assessed two ways: 1 a similarity of x to the set of shared terms is used to determine how substitutable x is for the shared term; and 2 the contexts of the LHS phrases and RHS phrases are compared to determine whether they support the equivalence of the two phrases. For simplicity, only single words were accepted as slot fillers, and only unary PPs were considered for this evaluation.

Specifically, x is only admitted (i.e., LHSx=RHSx is an OP, where x is the candidate slot filler and R/LHSx is the R/LHS of the PP with x replacing the (single) slot) if two tests are met: there is a c ∈ CW of PP such that x and c have sufficiently similar contexts, and LHSx and RHSx have sufficiently similar contexts. The test of similarity of context is from Lin and Pantel (2001), and uses a single contextual feature, i.e. the co-occurring words in a fixed size 6 word window (ignoring offset) around the word x/c, or the phrase R/LHSx.

In conclusion, the number of OPs generated with the non-parallel corpus set to the unilingual side of the parallel corpus (with the phrases that were used to derive the PP removed) was 86,363,252.

### EXAMPLE 2

The present invention was tested for generating English paraphrases using a parallel bilingual (English/Japanese) patent corpus. The corpus was Japanese-English Patent Translation data consisting of 3.2 million sentence pairs (Fujii et al., 2010) including 122.4 million morphemes in Japanese and 105.8 million words in English. MeCab, a publicly available program, was used for segmentation of the Japanese sentences and a tokenizer bundled in a phrase-based statistical machine translation system “PORTAGE” (Sadat et al., 2005) was used for the English sentences. In some experiments, the 1993 chapter of English patent corpus consisting of 16.7 million sentences (600 million words) was used as the non-parallel corpus. FIG. 4 is a table showing the number of acquired paraphrases at the various steps.

An initial set of cleaned SPs was obtained in the same manner in Example 1, except that 149 Japanese morphemes were used for cleaning up paraphrases. The number of SPs was 62,687,866. The effect of the cleaning and filtering was that over 90% of the raw paraphrases were discarded.

The number of unique PPs automatically generated was 20,789,290. Similarly to Example 1, PPs that did not cover at least 3 unique instances in SP were discarded. This constrained removed more than 80% of the PPs.

The number of OPs generated with the English side of the parallel corpus (with the phrases that were used to derive the PP removed) was 564,954,929. With the use of the additional monolingual (non-parallel) corpus, the PPs generated 2,103,277,992 OPs. This shows that substantial improvement over known pivot-based paraphrase acquisition techniques is possible. Analysis of the 2,103,277,992 OPs was not performed, but it is expected that the OPs are not replete with hypernym, hyponym, and antonym, pairings because of the reliance on the more directly accessed paraphrase information from the parallel corpus.

### EXAMPLE 3

The present invention was tested for generating English paraphrases in 8 English/French settings, and the quality of paraphrases in one setting was manually evaluated. The parallel corpus was version 6 of the Europarl Parallel Corpus, and the monolingual corpus included the English side of the bilingual corpus and an external corpus. The external monolingual corpus was the English side of GigaFrEn (http://statmt.org/wmt10/training-giga-fren.tar) consisting of 23.8 million sentences (648.8 million words), which was created by crawling the Web. In total, the monolingual corpus contained 25.6 million sentences (699.3 million words). Segmentation and tokenization were performed as described above in relation to Example 1. 7 other versions of smaller bilingual corpora were created by sampling sentence pairs of the full-size corpus (in the proportions ½, ¼, ⅛, 1/16, 1/32, 1/64, 1/128).

Phrase alignments were obtained from PORTAGE, as before, except that only the IBM2 (and not HMM) alignment procedures, was used for the present examples. Obtained phrase translations were then filtered and cleaned as described in Example 1. The initial set of SPs was also filtered as described in Example 1. Specifically, in addition to the filtering performed above, pairs of paraphrases whose conditional probability was less than 0.01 or whose contextual similarity equals to 0 were also removed. This is a conventional filtering method.

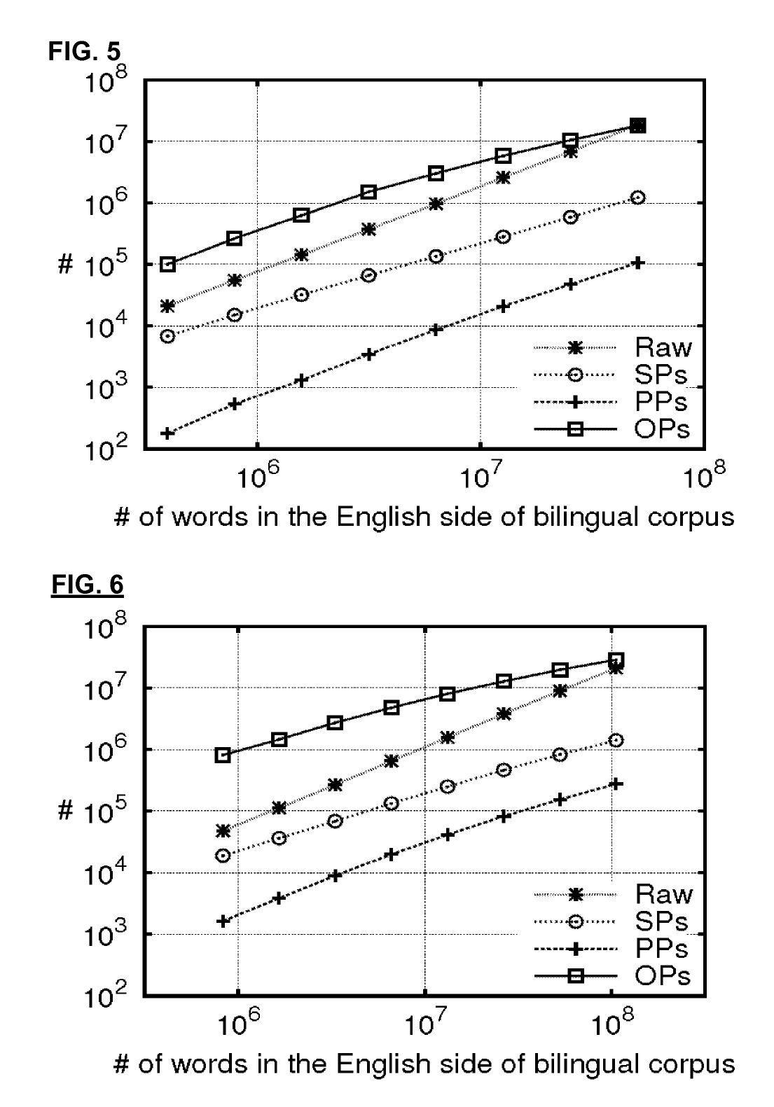

FIG. 5 graphs the counts of raw paraphrases produced by the SMT, the cleaned and filtered SPs, the PPs derived therefrom, and the OPs, for each of the 8 sizes of bilingual corpora. The effect of the cleaning and filtering was that over 60% of the raw paraphrases were discarded. The larger the bilingual corpus, the higher the rate of discarding is. When the full size of the bilingual corpus was used, over 93% of the raw paraphrases were filtered out, and 1,219,896 paraphrases were retained as SPs. When the full size of the bilingual corpus was used, the number of the PPs was 105,649. In this example, all the PPs were retained irrespective of the number of SPs that were corresponding to each PP. Only the unary patterns (patterns with only one slot) were retained for generating OPs. A substantially negligible fraction of the PPs (7-12%) had two or more slots.

For each PP, a search of the monolingual corpus was made for the LHS and RHS phrases, and a list of instances were compiled (with stop words removed). Each instance is associated with a unique candidate slot filler. When generating the OP list, assessment of candidate slot fillers used a slightly different similarity of context measure than that of Example 1. The test of similarity of context is the cosine of the angle between two feature vectors each of which represents LHSx and RHSx, which must be greater than 0. As contextual features for representing a phrase with a vector, all of the 1- to 4-grams of words that are adjacent to each occurrence of the phrase were first extracted. Then the feature vector is composed by aggregating features for all occurrences of the phrase. This is a compromise between computationally less expensive but noisier approaches, such as bag-of-words in Example 1, and more accurate but more computationally expensive approaches that incorporate syntactic features (Lin and Pantel, 2001). When the full size of the bilingual corpus was used, the number of OPs generated with the monolingual corpus (with the phrases that were used to derive the PP removed) was 18,123,306. The ratio of the numbers of OPs against those of SPs for each of the 8 sizes of bilingual corpora was ranging between 14.8 and 22.8.

Manual analysis of the (largest) collections of OPs was performed. The quality of randomly sampled SPs and OPs were assessed though paraphrase substitution in context. A pair of LHS and RHS was assessed by comparing a sentence which contains LHS and a paraphrased sentence in which LHS is replaced with RHS. Two criteria proposed in (Callison-Burch, 2008) were used: one is whether the paraphrased sentence is grammatical or not, and the other is whether the meaning of the original sentence is properly retained by the paraphrased sentence. Both grammaticality and meaning were scored with 5-point scales (1: bad, 5: good). For 70 sentences randomly sampled from WMT 2008-2011 “newstest” data, 55 pairs of sentences were generated using SPs and 295 pairs of sentences were generated using OPs. The average scores for 55 SPs were 4.60 for grammaticality and 4.35 for meaning. Those for 295 OPs were 4.22 for grammaticality and 3.35 for meaning. When paraphrases whose grammaticality score was 4 or above were regarded as correct as in (Callison-Burch, 2008), 85% of SPs and 74% of OPs were correct. When paraphrases whose meaning score is 3 or above were regarded as correct as in (Callison-Burch, 2008), 93% of SPs and 67% of OPs were correct. Percentages of paraphrases that are correct in terms of both grammaticality and meaning were 78% for SPs, which was substantially higher than that in a prior art (Callison-Burch, 2008), and 55% for OPs, which were comparable to the results in a prior art (Callison-Burch, 2008). By setting a larger threshold values for filtering SPs, the average score and percentage of correct paraphrases in terms of both grammaticality and meaning were improved for both SPs and OPs. As expected the OPs were not replete with hypernym, hyponym, and antonym, pairings because of the reliance on the more directly accessible paraphrase information from the parallel corpus.

### EXAMPLE 4

The present invention was tested for generating English paraphrases in 8 English/Japanese settings. The parallel corpus was the Japanese-English Patent Translation data (Fujii et al., 2010). The monolingual corpus consisted of the English side of the bilingual corpus and an external monolingual corpus, consisting of 30.0 million sentences (626.5 million words). In total the monolingual corpus contained 33.2 million sentences (732.3 million words). Segmentation and tokenization were performed as described above in relation to Example 2. 7 other versions of smaller bilingual corpora were created as in Example 3. Phrase alignment, phrase translation filtering, and filtering of the initial SPs were performed as in Example 3.

FIG. 6 graphs the counts of raw paraphrases produced by SMT, the cleaned and filtered SPs, the PPs derived therefrom, and the OPs, for each of the 8 sizes of bilingual corpora. The effect of the cleaning and filtering was that over 60% of the raw paraphrases were discarded. The larger the bilingual corpus, the higher the rate of discarding is. When the full size of the bilingual corpus was used, over 93% of the raw paraphrases were filtered out, and 1,410,934 paraphrases were retained as SPs. When the full size of the bilingual corpus was used, the number of unique PPs was 275,834. Similar to Example 3, only the unary patterns (patterns with only one slot) were retained for generating OPs, irrespective of the number of SPs that were corresponding to each PP. A substantially negligible fraction of the PPs (9-20%) had two or more slots.

For each PP, a search of the monolingual corpus was made for the LHS and RHS phrases, and a list of instances were compiled (with stop words removed). Each instance is associated with a unique candidate slot filler. When generating the OP list, assessment of candidate slot fillers is performed as in Example 3. In conclusion, when the full size of the bilingual corpus was used, the number of OPs generated with the monolingual corpus (with the phrases that were used to derive the PP removed) was 28,737,024. The ratio of the numbers of OPs against those of SPs for each of the 8 sizes of bilingual corpora was ranging between 20.3 and 42.9. The smaller the bilingual corpus, the higher the ratio was.

### REFERENCES

The contents of the entirety of each of which are incorporated by this reference:
Colin Bannard and Chris Callison-Burch. 2005. Paraphrasing with bilingual parallel corpora. In Proceedings of the 43rd Annual Meeting of the Association for Computational Linguistics (ACL), pp. 597-604.
Regina Barzilay and Lillian Lee. 2003. Learning to paraphrase: An unsupervised approach using multiple-sequence alignment. In Proceedings of the 2003 Human Language Technology Conference and the North American Chapter of the Association for Computational Linguistics (HLT-NAACL), pp. 16-23.
Rahul Bhagat and Deepak Ravichandran. 2008. Large scale acquisition of paraphrases for learning surface patterns. In Proceedings of the 46th Annual Meeting of the Association for Computational Linguistics (ACL), pp. 161-170.
Chris Callison-Burch. 2008. Syntactic constraints on paraphrases extracted from parallel corpora. In Proceedings of the 2008 Conference on Empirical Methods in Natural Language Processing (EMNLP), pp. 196-205.
Michel-Marie Deza and Elena Deza. 2006. Dictionary of Distances. Elsevier Science.
Atsushi Fujii, Masao Utiyama, Mikio Yamamoto, Takehito Utsuro,Terumasa Ehara, Hiroshi Echizen-ya, and Sayori Shimohata. 2010. Overview of the patent translation task at the NTCIR-8 workshop. In Proceedings of NTCIR-8 Workshop Meeting, pp. 371-376.
Atsushi Fujita, Shuhei Kato, Naoki Kato, and Satoshi Sato. 2007. A compositional approach toward dynamic phrasal thesaurus. In Proceedings of the ACL-PASCAL Workshop on Textual Entailment and Paraphrasing (WTEP), pp. 151-158.
Atsushi Fujita and Satoshi Sato. 2008. A probabilistic model for measuring grammaticality and similarity of automatically generated paraphrases of predicate phrases. In Proceedings of the 22nd International Conference on Computational Linguistics (COLING), pp. 225-232.
Zellig Harris. 1954. Distributional structure. Word 10 (23):146-162.
Ali Ibrahim, Boris Katz, and Jimmy Lin. 2003. Extracting structural paraphrases from aligned monolingual corpora. In Proceedings of the 2nd International Workshop on Paraphrasing: Paraphrase Acquisition and Applications (IWP), pp. 57-64.
Christian Jacquemin. 1999. Syntagmatic and paradigmatic representations of term variation. In Proceedings of the 37th Annual Meeting of the Association for Computational Linguistics (ACL), pp. 341-348.
Howard Johnson, Joel Martin, George Foster, and Roland Kuhn. 2007. Improving translation quality by discarding most of the phrase table. In Proceedings of the 2007 Conference on Empirical Methods in Natural Language Processing and Computational Natural Language Learning (EMNLP-CoNLL), pp. 967-975.
Philipp Koehn. 2009. Statistical Machine Translation. Cambridge University Press.
Samuel Larkin, Boxing Chen, George Foster, Ulrich Germann, Eric Joanis, Howard Johnson, and Roland Kuhn. 2010. Lessons from NRC's Portage System at WMT 2010. In Proceedings of the Joint 5th Workshop on Statistical Machine Translation and MetricsMATR, pp. 133-138.
Dekang Lin and Patrick Pantel. 2001. Discovery of inference rules for question answering. Natural Language Engineering, 7(4):343-360.
Igor Mel'\check{c}uk and Alain Polguère. 1987. A formal lexicon in Meaning-Text Theory (or How to do lexica with words). Computational Linguistics, 13(3-4):261-275.
Bo Pang, Kevin Knight, and Daniel Marcu. 2003. Syntax-based alignment of multiple translations: Extracting paraphrases and generating new sentences. In Proceedings of the 2003 Human Language Technology Conference and the North American Chapter of the Association for Computational Linguistics (HLT-NAACL), pp. 102-109.
Deepak Ravichandran and Eduard Hovy. 2002. Learning surface text patterns for a question answering system. In Proceedings of the 40th Annual Meeting of the Association for Computational Linguistics (ACL), pp. 215-222.
Fatiha Sadat, Howard Johnson, Akakpo Agbago, George Foster, Roland Kuhn, Joel Martin, and Aaron Tikuisis. 2005. PORTAGE: A phrase-based machine translation system. In Proceedings of the ACL Workshop on Building and Using Parallel Texts, pp. 129-132.
Yusuke Shinyama, Satoshi Sekine, Kiyoshi Sudo, and Ralph Grishman. 2002. Automatic paraphrase acquisition from news articles. In Proceedings of the 2002 Human Language Technology Conference (HLT).
Idan Szpektor, Hristo Tanev, Ido Dagan, and Bonaventura Coppola. 2004. Scaling Web-based acquisition of entailment relations. In Proceedings of the 2004 Conference on Empirical Methods in Natural Language Processing (EMNLP), pp. 41-48.
Idan Szpektor and Ido Dagan. 2008. Learning entailment rules for unary templates. In Proceedings of the 22nd International Conference on Computational Linguistics (COLING). 849-856.
Hristo Tanev. 2010. Method for the extraction of relation patterns from articles. US 2010/0138216.
Shiqi Zhao, Haifeng Wang, Ting Liu, and Sheng Li. 2008. Pivot approach for extracting paraphrase patterns from bilingual corpora. In Proceedings of the 46th Annual—Meeting of the Association for Computational Linguistics (ACL), pp. 780-788.
Shiqi Zhao, Haifeng Wang, Ting Liu, and Sheng Li. 2009. Extracting paraphrase patterns from bilingual parallel corpora. Natural Language Engineering, 15(4):503-526.

Other advantages that are inherent to the structure are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

1. A computer based natural language processing method for identifying paraphrases in corpora using statistical analysis, the computer based method comprising:
deriving a set of starting paraphrases (SPs) from a parallel corpus, each SP having at least two phrases that are phrase aligned,
generating a set of paraphrase patterns (PPs) by identifying shared terms within two aligned phrases of an SP, and defining a PP having slots in place of the shared terms, in right hand side (RHS) and left hand side (LHS) expressions, and
collecting output paraphrases (OPs) by identifying instances of the PPs in a non-parallel corpus.

2. The computer based method of claim 1 wherein the parallel corpus is a multilingual parallel corpus or a monolingual parallel corpus, and the non-parallel corpus is a unilingual side of the parallel corpus and/or an external monolingual non-parallel corpus.

3. The computer based method of claim 1 wherein deriving the SPs from a parallel corpus comprises filtering a set of aligned phrases.

4. The computer based method of claim 3 wherein filtering comprises:
applying at least one syntactic or semantic rule for culling SP candidates,
removing stop words from SP candidates,
removing SP candidates that differ by only stop words, or
removing SP candidates that have word subsequences with higher weights than other candidates as candidate paraphrases of a given phrase.

5. The computer based method of claim 1 wherein the parallel corpus is a multilingual corpus and deriving the SPs comprises identifying phrases that are aligned by translation to a common phrase in a pivot language.

6. The computer based method of claim 1 wherein deriving the SPs comprises:
taking a parallel corpus having alignment at the morpheme, word, sentence or paragraph level, and generating phrase alignments to the extent possible,
taking a parallel corpus having alignment at the phrase level, and cleaning the phrase level alignments to select those most likely to provide strong SPs,
taking a multilingual parallel corpus having alignment at the morpheme, word, sentence or paragraph level, and generating word alignments by statistical machine translation, followed by partitioning sentences into phrases,
taking a multilingual parallel corpus having alignment at the phrase level, and cleaning the phrase level alignments to select those most likely to provide strong SPs using translation weights from morpheme, word, phrase, sentence, paragraph, context, or metatextual data, levels, or
taking a multilingual parallel corpus having alignment at the phrase level, and cleaning the phrase level alignments to select those most likely to provide strong SPs using translation weights from alignments from each of two or more pivot languages.

7. The computer based method of claim 1 wherein identifying shared terms comprises:
identifying shared terms as words having a “letter same” relation,
identifying shared terms as words having a same lemma,
identifying shared terms as words associated by lexical derivations or lexical functions, or
identifying shared terms by applying morpheme based analysis to the words of the phrases in the SPs.

8. The computer based method of claim 1 wherein collecting OPs comprises:
determining whether each PP has sufficient instantiation in the parallel corpus and discarding PPs that do not, prior to searching the non-parallel corpus, or
searching in the non-parallel corpus for the PP, and discarding the PP if there is insufficient instantiation.

9. The computer based method of claim 1 wherein collecting OPs comprises:
cataloging all slot fillers that occur in the non-parallel corpus in both RHS and LHS instantiations,
performing preliminary statistics on the slot fillers and their variety to determine strength of the PP, and
constructing a candidate paraphrase for every instantiation having sufficient RHS and LHS instantiations.

10. The computer based method of claim 1 wherein collecting OPs comprises applying a test to rank a candidate paraphrase for inclusion in the set of OPs.

11. The computer based method of claim 10 wherein applying the test comprises computing a similarity of contexts of the instances of the LHS and RHS expressions.

12. The computer based method of claim 10 wherein applying the test comprises computing a similarity of contexts of the shared terms and slot fillers identified from the PP instances in the non-parallel corpus.

13. The computer based method of claim 10 wherein applying the test comprises identifying word forms or semantic classes of slot fillers identified from PP instances in the non-parallel corpus to assess substitutability.

14. The computer based method of claim 10 wherein the parallel corpus is a multilingual aligned parallel corpus, and the non-parallel corpus is a unilingual side of the parallel corpus.

15. An apparatus adapted to perform the method of any of claims 1-14.
